(19) United States
(12) Patent Application Publication
(10) Pub. No.: US 2015/0222077 A1
(43) Pub. Date: Aug. 6, 2015

(54) METHOD FOR CONTROLLING VARIABLE WAVELENGTH LASER, AND VARIABLE WAVELENGTH LASER DEVICE

(71) Applicant: Sumitomo Electric Device Innovations, Inc., Yokohama-shi (JP)

(72) Inventor: Mitsuyoshi MIYATA, Yokohama-shi (JP)

(21) Appl. No.: 14/610,823

(22) Filed: Jan. 30, 2015

(30) Foreign Application Priority Data
Jan. 31, 2014 (JP) 2014-016909

(51) Int. Cl. H01S 3/10

(52) U.S. Cl. CPC H01S 3/10

(57) ABSTRACT

A method for controlling a variable wavelength laser comprises: acquiring information indicating a value of a second wavelength different from a first wavelength, information indicating a wavelength difference with respect to the first wavelength, and a first control value defining wavelength characteristics of an etalon and a first target setting value for the etalon; a second step of selecting the following calculations based on the wavelength difference, the first target setting value and the first control value: calculation of a second target setting value for the etalon; calculation of a second control value defining wavelength characteristics of the etalon; and calculation of the both values; and setting, as the second target setting value, a control target value of a wavelength detection result obtained by a wavelength detecting section, and controlling a wavelength of the variable wavelength laser, if the calculation of the second target setting value is carried out.

### BACKGROUND OF THE INVENTION

1. Field of the Invention

The present invention relates to a method for controlling a variable wavelength laser and a variable wavelength laser device,

2. Related Background Art

Japanese Patent Application Publication No. 2009-026996 discloses a variable wavelength laser in which the output wavelength can be selected.

### SUMMARY OF THE INVENTION

In the technology disclosed in the above patent document, control conditions for obtaining a grid wavelength in accordance with the International Telecommunication Union Telecommunication (ITU-T) Standardization. Sector are stored in a memory, and the control of the variable wavelength laser is carried out on the basis of the stored control conditions to lase at any of the grid wavelengths. What is needed for a variable wavelength laser of this kind is to operate so as to lase at a desired wavelength (referred to as “grid-less control”), rather than at a designated wavelength. When grid-less control is carried out by one method, the flexibility thereof is not high.

An object of one aspect of the present invention is to provide a method for controlling a variable wavelength laser which achieves grid-less control with a high flexibility, and a variable wavelength laser device which achieves grid-less control with a high flexibility.

One aspect of the present invention relates to a method for controlling a variable wavelength laser. The method for controlling a variable wavelength laser with a memory storing drive conditions for lasing at a first wavelength, a lasing wavelength of the variable wavelength laser being controlled based on a difference between a target value and a wavelength detection result in the method, the wavelength detection result being provided by a wavelength detecting section having an etalon, the method comprising: a first step of acquiring second-wavelength information, wavelength-difference information, and a first control value and a first target setting value from among the drive conditions, the second-wavelength information indicating a value of a second wavelength different from the first wavelength, the wavelength-difference information indicating a wavelength difference with respect to the first wavelength, the first target setting value being provided for the etalon, and the first control value defining wavelength characteristics of the etalon; a second step of selecting one of the following calculations based on the wavelength difference, the first target setting value and the first control value: calculation of a second target setting value for the etalon; calculation of a second control value defining wavelength characteristics of the etalon; and calculation of both the second target setting value and the second control value, the second target setting value corresponding to the second wavelength, and the second control value corresponding to the second wavelength, and carrying out the calculation thus selected; and a third step of, if the calculation of the second target setting value is carried out in the second step, setting a control target value of a wavelength detection result as the second target setting value and controlling a wavelength of the variable wavelength laser, the wavelength detection result being obtained by the wavelength detecting section.

A further aspect of the present invention relates to a variable wavelength laser device. The variable wavelength laser device comprises: a variable wavelength laser; a wavelength detecting section including an etalon, the wavelength detecting section detecting a wavelength of output light emitted by the variable wavelength laser; a memory storing drive conditions of the variable wavelength laser; and a controller: which acquires second-wavelength information, wavelength-difference information, and a first control value and a first target setting value from among the drive conditions on the basis of a difference between a target value and a wavelength detection result from the wavelength detecting section, the second-wavelength information indicating a second wavelength, the second wavelength being different from a first wavelength, the wavelength-difference information indicating a wavelength difference with respect to the first wavelength, the first target setting value being provided for the etalon, and the first control value determining wavelength characteristics of the etalon; which selects, on the basis of the wavelength difference, the first target setting value and the first control value, one of the following: to perform calculation of a second target setting value for the etalon, the second target setting value corresponding to the second wavelength; to perform calculation of a second control value determining wavelength characteristics of the etalon, the wavelength characteristics of the etalon corresponding to the second wavelength; and to perform calculation of both the second target setting value and the second control value, and implements a selected one; and which controls a wavelength of the variable wavelength laser by using, as the second target setting value, a control target value of a wavelength detection result obtained by the wavelength detecting section, in response to the selection of the calculation of the second target setting value.

### BRIEF DESCRIPTION OF THE DRAWINGS

The foregoing and other objects, features and advantages of the invention will become more readily apparent from the following detailed description of a preferred embodiment of the invention which proceeds with reference to the accompanying drawings.

FIG. 1 is a block diagram showing the general configuration of a variable wavelength laser device according to an embodiment of the present invention;

FIG. 2 is a cross-sectional schematic view showing the general configuration of a semiconductor laser for the variable wavelength laser device;

FIG. 3 is a diagram indicating the initial setting values and feedback control target values;

FIG. 4 is a diagram showing a relationship between a target value Iₘ₂/Iₘ₁ and a fundamental wavelength of each channel.

FIG. 5 is a diagram illustrating the relationship between a required wavelength and a fundamental wavelength in grid-less control;

FIG. 6A is a diagram showing a method for the grid-less control;

FIG. 6B is a diagrams showing a method for a grid-less control;

FIG. 7 is a diagram showing a correction coefficient;

FIG. 8 is a diagram showing a method for a grid-less control;

FIG. 9A is a diagram showing a method for the grid-less control;

FIG. 9B is a diagram showing a method for the grid-less control;

FIG. 10 is a systematic view showing a table for grid-less control; and

FIG. 11 is a diagram showing a flowchart of grid-less control in one example.

### DESCRIPTION OF THE PREFERRED EMBODIMENTS

Several practical examples are described below.

One embodiment according to the one aspect relates to a method for control a variable wavelength laser. In the method for controlling a variable wavelength laser with a memory storing drive conditions for lasing at a first wavelength, a lasing wavelength of the variable wavelength laser is controlled based on a difference between a target value and a wavelength detection result in the method; the wavelength detection result is provided by a wavelength detecting section having an etalon. The method comprises: a first step of acquiring second-wavelength information, wavelength-difference information, and a first control value and a first target setting value from among the drive conditions, the second-wavelength information indicating a value of a second wavelength different from the first wavelength, the wavelength-difference information indicating a wavelength difference with respect to the first wavelength, the first target setting value being provided for the etalon, and the first control value defining wavelength characteristics of the etalon; a second step of selecting one of the following calculations based on the wavelength difference, the first target setting value and the first control value: calculation of a second target setting value for the etalon; calculation of a second control value defining wavelength characteristics of the etalon; and calculation of both the second target setting value and the second control value, the second target setting value corresponding to the second wavelength, and the second control value corresponding to the second wavelength, and carrying out the calculation thus selected; and a third step of, if the calculation of the second target setting value has been carried out in the second step, setting a control target value of a wavelength detection result as the second target setting value and controlling a wavelength of the variable wavelength laser, the wavelength detection result being obtained by the wavelength detecting section.

In an example according to the above embodiment, the selection in the second step is made on the basis of a sign of a wavelength difference between the first wavelength and the second wavelength.

In an example according to the above embodiment, a control value determining the wavelength characteristics of the etalon indicates a temperature of the etalon; the temperature of the etalon is controlled by a temperature control device including a Peltier element; and a selection that a power consumption of the temperature control device becomes small is made in the second step.

In an example according to the above embodiment, in a procedure in which both the second target setting value and the second control value are calculated in the second step, the second target setting value is shifted towards a value enabling a small power consumption of the temperature control device.

In an example according to the above embodiment, in a procedure in which both the second target setting value and the second control value are calculated in the second step, the second control value is calculated when the wavelength difference is outside a variable range of the second target setting value.

In an example according to the above embodiment, the selection of the second step is made on the basis of a relationship between the temperature of the etalon and an ambient temperature of the etalon.

One embodiment according to another aspect relates to a variable wavelength laser device. The variable wavelength laser device comprises: a variable wavelength laser; a wavelength detecting section including an etalon, and the wavelength detecting section detecting a wavelength of output light emitted by the variable wavelength laser; a memory storing drive conditions of the variable wavelength laser; and a controller: which acquires second-wavelength information, wavelength-difference information, and a first control value and a first target setting value from among the drive conditions on the basis of a difference between a target value and a wavelength detection result provided by the wavelength detecting section, the second-wavelength information indicating a second wavelength, the second wavelength being different from a first wavelength, the wavelength-difference information indicating a wavelength difference with respect to the first wavelength, the first target setting value being provided for the etalon, and the first control value determining wavelength characteristics of the etalon; which selects, on the basis of the wavelength difference, the first target setting value and the first control value, one of the following: to perform calculation of a second target setting value for the etalon, the second target setting value corresponding to the second wavelength; to perform calculation of a second control value determining the wavelength characteristics of the etalon, the wavelength characteristics of the etalon corresponding to the second wavelength; and to perform calculation of both the second target setting value and the second control value, and implements a selected one; and which controls a wavelength of the variable wavelength laser by using, as the second target setting value, a control target value of a wavelength detection result obtained by the wavelength detecting section, in response to the selection of the calculation of the second target setting value.

In an example according to the above embodiment, the controller makes a selection on the basis of a sign of a wavelength difference between the first wavelength and the second wavelength.

An example according to the above embodiment further comprises a temperature control device including a Peltier device, and the Peltier device controls the temperature of the etalon. A control value defining the wavelength characteristics of the etalon is the temperature of the etalon, and the controller selects a temperature, which makes a power consumption of the temperature control device small, for the etalon.

In one example according to the above embodiment, in the selection in which both the second target setting value and the second control value are calculated, the controller shifts the second target setting value towards a value enabling a power consumption of the temperature control device to become small.

In one example according to the above embodiment, in the selection in which both the second target setting value and the second control value are calculated, the controller calculates the second control value when the wavelength difference is outside a variable range of the second target setting value.

In one example according to the above embodiment, the controller makes a selection of the second step on the basis of a relationship between the temperature of the etalon and an ambient temperature of the etalon.

One example according to the above embodiment further comprises a temperature detecting section which detects the temperature of the etalon.

Embodiments of a method for controlling a variable wavelength laser and a variable wavelength laser device according to the present invention are described below with reference to the drawings. The present invention is not limited to these embodiments.

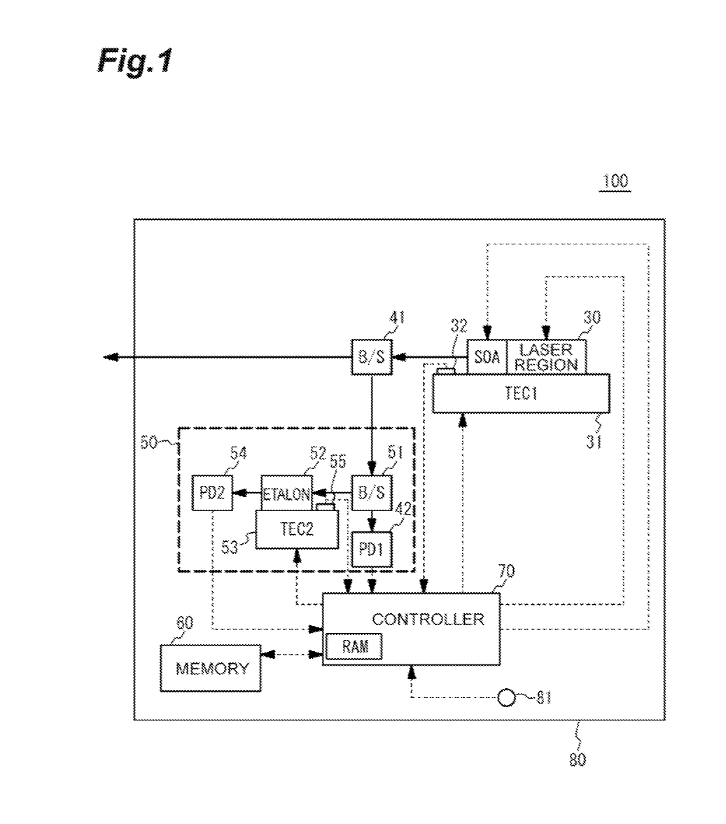

FIG. 1 is a block diagram showing the general configuration of the variable wavelength laser device 100 according to a first embodiment of the invention. As shown in FIG. 1, the variable wavelength laser device 100 comprises a semiconductor laser 30 (tunable semiconductor laser) acting as a laser, and the wavelength of the semiconductor laser 30 is controllable. The semiconductor laser 30 according to the present embodiment includes a region adjacent to a laser region, and this region comprises a semiconductor optical amplifier (SOA). This SOA functions as an optical output control section. The SOA can increase or decrease the intensity of the laser beam for optical output, as required. Furthermore, the SOA can also control the intensity of the optical output to substantially zero. Moreover, the variable wavelength laser device 100 also comprises a detection section 50, a memory 60, and a controller 70, and the like. The detecting section 50 functions as an output detection section and a wavelength locking section. The controller 70 controls a semiconductor laser in the variable wavelength laser device 100, and contains a random access memory (RAM) therein. Each section of the variable wavelength laser 100 is arranged in a chassis 80.

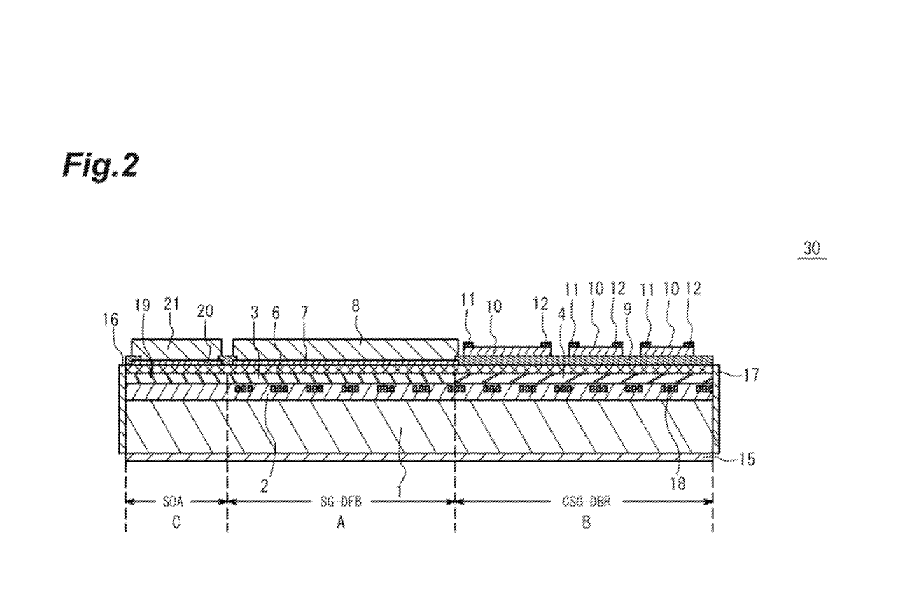

FIG. 2 is a schematic cross-sectional view showing the general configuration of a semiconductor laser 30 according to the present embodiment. As shown in FIG. 2, the semiconductor laser 30 comprises: a sampled grating distributed feedback (referred to as “SG-DFB”) region A; a chirped sampled grating distributed Bragg reflector (referred to as “CSG-DB”) region B; and a semiconductor optical amplifier (referred to as “SOA”) region C. Accordingly, the semiconductor laser 30 has a wavelength selecting mirror in the semiconductor structure thereof.

In one example for the present embodiment, the SOA region. C, SG-DFB region A, and CSG-DBR region B are arranged in this order in the direction from the front end of the semiconductor laser 30 to the rear end. The SG-DFB region A has an optical gain and is provided with a sampled grating. The CSG-DBR region B has no optical gain and is provided with a sampled grating. The SG-DFB region A and the CSG-DBR region B correspond to the laser region shown in FIG. 1, and the SOA region C corresponds to the SOA region shown in FIG. 2.

The SG-DFB region A has a structure in which a lower cladding layer 2, an active layer 3, an upper cladding layer 6, and a contact layer 7 are stacked on the substrate 1 to form the semiconductor stack, and an electrode 8 is provided on the semiconductor stack. The CSG-DBR region B has a structure in which a lower cladding layer 2, an optical waveguide layer 4, an upper cladding layer 6, and an insulating film 9 are stacked on the substrate 1 to form a stack, and plural heaters 10 are arranged on the stack. The heaters 10 are each provided with a power source electrode 11 and a ground electrode 12. The SOA region C has a structure in which a lower cladding layer 2, an optical amplification layer 19, an upper cladding layer 6, and a contact layer 20 are stacked on the substrate 1 to form a stack, and an electrode 21 is located on the stack.

The substrate 1, the lower cladding layer 2 and the upper cladding layer 6 are integrally formed to extend over the SG-DFB region A, the CSG-DBR region. B and the SOA region C. The active layer 3, the optical waveguide layer 4 and the optical amplification layer 19 are formed to extend along a single plane. The boundary between the SG-DFB region A and the CSG-DBR region B is located at the boundary between the active layer 3 and the optical waveguide layer 4.

An end face film 16 is formed on the end face of one end part, which contains the SOA region C, of the variable wavelength laser 100, and the end face of the one end part comprises the end face of the substrate 1, the end face of the lower cladding layer 2, the end face of the optical amplification layer 19 and the end face of the upper cladding layer 6. In the present embodiment, the end face film 16 is provided for an anti-reflection (AR) film. The end face film 16 constitutes a front end face of the semiconductor laser 30. An end face film 17 is formed on the end face of another end part, containing the CSG-DBR region B, of the variable wavelength laser device 100, and the end face of the other end part comprises the end face of the substrate 1, the end face of the lower cladding layer 2, the end face of the optical waveguide layer 4 and the end face of the upper cladding layer 6. In the present embodiment, the end face film 17 is provided for an AR film. The end face film 17 constitutes a rear end face of the semiconductor laser 30.

The substrate 1 is made of a crystalline substrate, the material of which is, for example, n-type InP. The lower cladding layer 2 has n-type conductivity whereas the upper cladding layer 6 has p-type conductivity, and the lower cladding layer 2 and the upper cladding layer both are made of, for example, InP. The lower cladding layer 2 and the upper cladding layer 6, which sandwiches the active layer 3, the optical waveguide layer 4 and the optical amplification layer 19 therebetween, confine light to the internal region including the active layer 3, the optical waveguide layer 4 and the optical amplification layer 19.

The active layer 3 is constituted by a semiconductor that can provide an optical gain. The active layer 3 has, for example, a quantum well structure; specifically a structure in which well layers each made of Ga_{0.32}In_{0.68}As_{0.92}P_{0.08} (with thickness of 5 nm) and barrier layers made of Ga_{0.22}In_{0.78}As_{0.47}P_{0.53} (with thickness of 10 nm) are stacked alternately. The optical waveguide layer 4 can be configured as, for example, a bulk semiconductor layer and can be made of, specifically, Ga_{0.22}In_{0.78}As_{0.47}P_{0.53}. In the present embodiment, the optical waveguide layer 4 has a larger energy gap than the active layer 3.

The optical amplification layer 19 has an optical gain in response to the injection of current from the electrode 21 to amplify light therein. The optical amplification layer 19 has, for example, a quantum well structure and, specifically, may have a structure in which well layers made of Ga_{0.35}In_{0.65}As_{0.99}P_{0.01} (with thickness of 5 nm) and barrier layers made of Ga_{0.15}In_{0.85}As_{0.32}P_{0.68} (with thickness of 10 nm) are stacked alternately. Furthermore, another example is as follows: a bulk semiconductor made of, for example, Ga_{0.44}In_{0.56}As_{0.95}P_{0.05}, can be applied to the optical amplification layer 19. The optical amplification layer 19 may be made of the same material as the active layer 3.

The contact layers 7, 20 can be made of, for example, p-type Ga_{0.47}In_{0.53}As crystal. The insulating film 9 acts as a protective film made of silicon nitride film (SiN) or silicon oxide film (SiO). Each heater 10 is provided with a thin film resistor made of titanium tungsten (TiW). The heaters 10 may be formed so as to extend beyond the boundary between adjacent segments in the CSG-DBR region B.

The electrodes 8, 21, the power source electrode 11 and the ground electrode 12 are made of a conductive material, such as gold (Au). A backside electrode 15 is formed on the rear side of the substrate 1. The backside electrode 15 is formed so as to extend over the SG-DFB region A, the CSG-DBR region B and the SOA region C.

The end face film 16 and the end face film 17 act as AR films having a reflectivity of not more than 1.0%, and have properties to make the end faces substantially non-reflective. The AR film can be made of dielectric stack layers of, for example, MgF₂ and TiON. In the present embodiment, the AR film is formed to constitute each of both ends of the laser, and alternatively the end face film 17 may be made of a reflective film with a significant reflectivity. The semiconductor region that is in contact with the end face film 17, as shown in FIG. 2, with a significant reflectivity may be provided with a structure including a light absorbing layer, so that this structure can suppress light from leaking through the end face film 17 outward. A significant reflectivity can be, for example, a reflectivity of not less than 10%. Here, “reflectivity” is defined as reflection in the inside of the semiconductor laser.

The diffraction gratings (corrugation) 18 are formed apart from each other in plural locations and arranged at a prescribed interval in the lower cladding layer 2 extending in the SG-DFB region A and the CSG-DBR region B. This arrangement forms a sampled grating in the SG-DFB region A and the CSG-DBR region B. In the SG-DFB region A and the CSG-DBR region B, plural segments are provided in the lower cladding layer 2. Here, a “segment” is defined as a region containing a single diffraction grating section and a single spacing section in contact with the single diffraction grating section, where the diffraction grating section contains a single diffraction grating 18 is provided and the spacing section contains no diffraction grating 18. In other words, the segment is defined as a region in which a spacing section, which is sandwiched by two diffraction grating sections located respectively at both ends of the spacing section, and one of these diffraction grating sections are joined. The diffraction grating 18 is made of a material having a refractive index different from the lower cladding layer 2. If the lower cladding layer 2 may be made of InP, and then the diffraction grating can be made of a material, for example, Ga_{0.22}In_{0.78}As_{0.47}P_{0.53}.

The diffraction grating 18 can formed by patterning using two-beam interference exposure. Spacing sections to be positioned between diffraction gratings 18 can be formed by carrying out the first exposure to transfer a pattern for the diffraction gratings 18 to a resist, thereby forming the patterned resist; and then carrying out the second exposure to the areas in which the spacing section are to be formed. The diffraction gratings 18 in the SG-DFB region A and the diffraction gratings 18 in the CSG-DBR region B may have the same pitch, or the pitch of the diffraction gratings 18 in the SG-DFB region A may be different from that of the diffraction gratings 18 in the CSG-DBR region B. In the present embodiment, for example, these pitches of the diffraction gratings 18 in the both regions A and B are set to be the same. Furthermore, in the segments, the diffraction gratings 18 in the SG-DFB region A and the CSG-DBR region B may have the same length or may have different lengths. Furthermore, the diffraction gratings 18 in the SG-DFB region A may have the same length, the diffraction gratings 18 in the CSG-DBR region B may have the same length, and the diffraction gratings 18 in the SG-DFB region A and the CSG-DBR region B may have different lengths.

The optical lengths of the segments in the SG-DFB region A are substantially the same as each other. The optical lengths of at least two segments among the segments in the CSG-DBR region B are formed so as to be different from each other. Accordingly, the intensities of the peaks in the wavelength characteristics in the CSG-DBR region B have a wavelength dependency. The average optical length of the segments in the SG-DFB region A and the average optical length of the segments in the CSG-DBR region B are different from each other. As described above, the arrangement of the segments in the SG-DFB region A and the arrangement of the segments in the CSG-DBR region B constitute an optical cavity for the semiconductor laser 30.

In each of the SG-DFB region A and the CSG-DBR region B, light components reflected thereby interferes with each other. The active layer 3 is provided in the SG-DFB region A, and the injection of carriers thereinto generates a discrete gain spectrum with plural peaks arrayed in a prescribed wavelength interval, and the intensities of the peaks are substantially uniform. Furthermore, a discrete reflection spectrum with plural peaks arrayed in a prescribed wavelength interval is in the CSG-DBR region B, and the plural peaks of the discrete reflection spectrum have different peak intensities. The arrangement of the peak wavelengths in the wavelength characteristics of the SG-DFB region A is different from that of the CSG-DBR region B. The combination of these wavelength characteristics thereof provides the Vernier effect to allow the selection of the wavelength that satisfies the lasing conditions.

As shown in FIG. 1, the semiconductor laser 30 is disposed on a first temperature control device 31. The first temperature control device 31 includes a Peltier device and functions as a thermoelectric cooler (TEC). The first thermistor 32 is also disposed on the first temperature control device 31. The first thermistor 32 detects the temperature of the first temperature control device 31. The temperature of the semiconductor laser 30 can be determined on the basis of the temperature detected by the first thermistor 32.

In the variable wavelength laser device 100, the detecting section 50 is located in front of the semiconductor laser 30. Since the detecting section 50 functions as a wavelength locker, the variable wavelength laser device 100 can be called a front locker type. The detection section 50 is provided with a first light receiving device 42, a beam splitter 51, an etalon 52, a second temperature control device 53, a second light receiving device 54, and a second thermistor 55.

The beam splitter 41 is disposed at a position at which the beam splitter 41 branches off an output beam coming from the front side of the semiconductor laser 30. The beam splitter 51 is disposed at a position at which the beam splitter 51 branches off an optical beam coming from the beam splitter 41. The first light receiving device 42 is disposed at a position at which the first light receiving device 42 can receive one of the two optical beams branched off by the beam splitter 51. The etalon 52 is disposed at a position at which the etalon 52 can receive the other of the two optical beams branched off by the beam splitter 51. The second light receiving device 54 is disposed at a position at which the second light receiving device 54 can receive an optical beam that has transmitted through the etalon 52.

The etalon 52 has transmission characteristics in which the transmittance changes periodically with increase or decrease in the wavelength of the light incident thereon. In the present embodiment, a solid etalon is used as the etalon 52. The periodic wavelength characteristics of the solid etalon change depending on the temperature thereof. The etalon 52 is disposed at a position at which the etalon 52 can receive the other of the two optical beams branched off by the beam splitter 51. Furthermore, the etalon 52 is disposed on the second temperature control device 53. The second temperature control device 53 includes a Peltier device and functions as a thermoelectric cooler (TEC).

The second light receiving device 54 is disposed at a position at which the second light receiving device 54 can receive an optical beam that has transmitted through the etalon 52. The second thermistor 55 is provided in order to determine the temperature of the etalon 52. The second thermistor 55 is disposed on, for example, the second temperature control device 53. In the present embodiment, the temperature of the second temperature control device 53 is detected by the second thermistor 55 to determine the temperature of the etalon 52.

The memory 60 function as a rewriteable storage device. A typical example of a rewriteable storage device can be a flash memory. The controller 70 comprises a central processing unit (CPU), a random access memory (RAM), a power source, and the like. The RAM, which functions as a memory, can temporarily stores programs to be executed by the central processing unit, data to be processed by the central processing unit, and the like.

A temperature detecting section 81 is disposed in the chassis 80. The temperature of the semiconductor laser 30 is controlled to provide the semiconductor laser 30 with a desired the lasing wavelength. The semiconductor laser 30 acts as a heat source, and the heat to be exhausted is transferred from the first temperature control device 31 to the chassis 80. Consequently, the temperature of the chassis 80 changes depending on the lasing wavelength of the semiconductor laser 30. The temperature detection section 81 detects the temperature of the housing 80 and transmits information on this temperature to the controller 70. The temperature detecting section 81 may be incorporated into the controller 70. The etalon 52 is affected by the temperature of the chassis 80. Consequently, the temperature of the chassis 80 can be regarded as the ambient temperature of the etalon 52.

The memory 60 stores an initial setting value for each section of the variable wavelength laser device 100, and feedback control target values, which are contained in association with the respective channels. The channels indicate identification numbers corresponding to the respective lasing wavelengths that the semiconductor laser 30 can provide. The wavelengths of the channels are determined to be arranged discretely in the variable-wavelength range of the variable wavelength laser device 100. For example, each channel corresponds to a grid wavelength (the interval of 50 GHz) in accordance with the International Telecommunication Union Telecommunication (ITU-T) Standardization Sector. Alternatively, initial setting values may be prepared which are arranged at narrower interval than a grid interval of the ITU-T. In the present embodiment, the wavelengths for the respective channels are defined as the fundamental wavelengths.

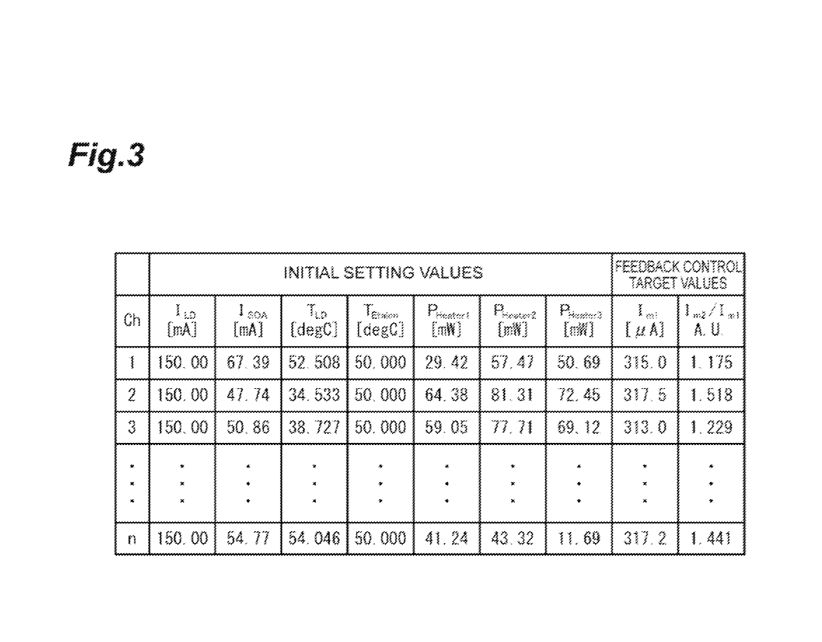

FIG. 3 is a diagram indicating the abovementioned initial setting values and feedback control target values. As shown in FIG. 3, the initial setting values include: an initial current value I_{LD} the current of which is supplied to the electrode 8 in the SG-DFB region A, an initial current value I_{SOA} the current of which is supplied to the electrode 21 in the SOA region C, an initial temperature value T_{LD} of the semiconductor laser 30, an initial temperature value T_{Etalon} of the etalon 52, and initial power values P_{Heater1} to P_{Heater3} which are supplied to the heaters 10. These initial setting values are determined for each channel. The feedback control target value is used as a target value in implementing feedback control of the controller 70. The feedback control target value includes a target value Iₘ₁ for the photocurrent provided by the first light receiving device 42, and a target value Iₘ₂/Iₘ₁ of the ratio between the photocurrent provided by the first light receiving device 42, and the photocurrent Iₘ₂ provided by the second light receiving device 54. The control target value is also set for each channel. These values are tuned with a wavelength meter for each individual variable wavelength laser 100 before shipment.

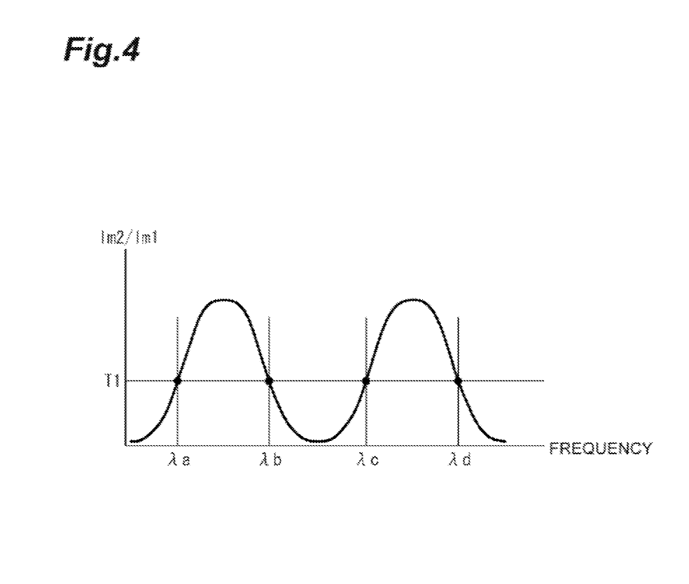

FIG. 4 is a diagram showing the relationship between the fundamental wavelengths of the channels and the target value Iₘ₂/Iₘ₁. In FIG. 4, the horizontal axis represents the wavelength (in frequency), and the vertical axis represents a target value Iₘ₂/Iₘ₁ (in the transmittance of the etalon 52). The transmission characteristics of the etalon 52 have a slope from a trough (bottom) to one top (peak) in the higher-frequency region with respect to the bottom, and a slope from the trough (bottom) to another top (peak) in the lower-frequency region, at least one of which is used in frequency tuning. Accordingly, for example, an etalon 52 may be prepared in which FSR/2 is equal to the frequency difference between the channels (for example, 50 GHz). When one of the above slopes can be used in frequency tuning, an etalon 52 having FSR-50 GHz may be used, where FSR is an abbreviation for free spectral region. In the example in FIG. 4, the target value Iₘ₂/Iₘ₁ is set to a prescribed value (T1) at each of the fundamental wavelengths λa to λd. The target value Iₘ₂/Iₘ₁ may be changed depending on each fundamental wavelength as shown in FIG. 3, in order to carry out the fine adjustment of wavelength. Control carried out such that the lasing wavelength matches with a fundamental wavelength is hereinafter referred to as “grid control.”

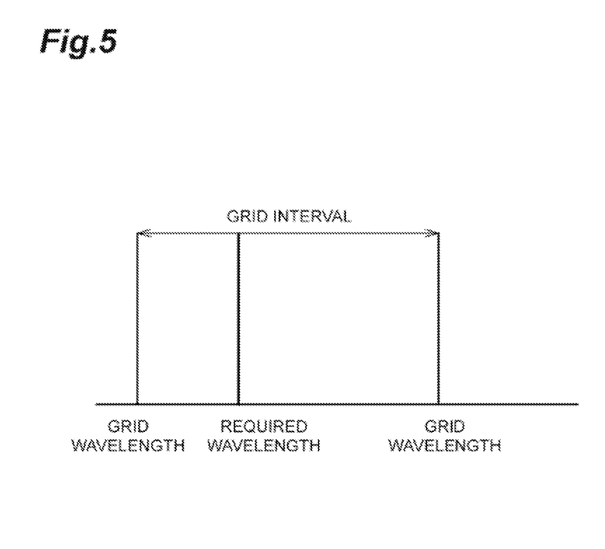

The variable wavelength laser 100 according to the present embodiment can provide a required wavelength that is not on the grid of the fundamental wavelengths. Control which enables the variable wavelength laser 100 to provide a wavelength different from the fundamental wavelengths is hereinafter called “grid-less control.” FIG. 5 is a diagram illustrating the relationship between the required wavelength and the fundamental wavelengths in grid-less control. As shown in FIG. 5, in grid-less control, the required wavelength can be located between one fundamental wavelength and another fundamental wavelength adjacent thereto, and the required wavelength may coincide with the fundamental wavelength.

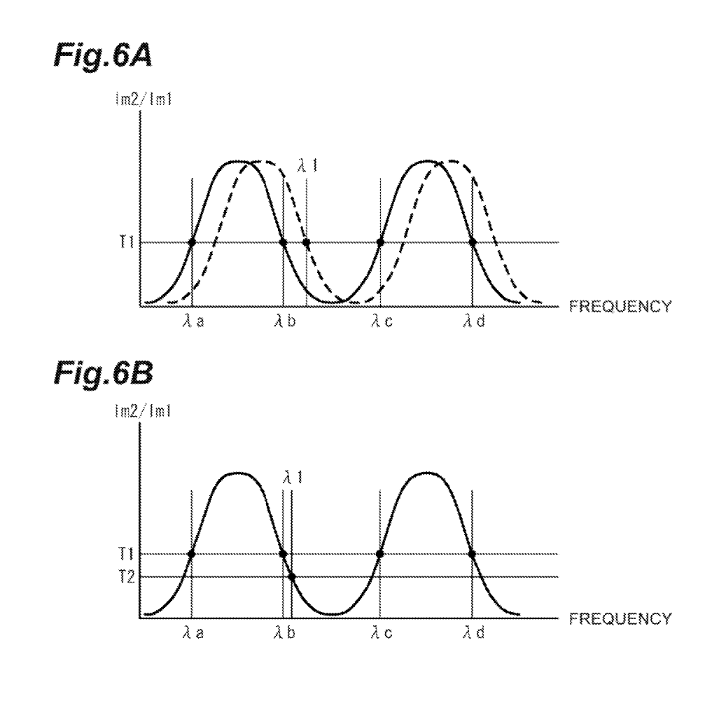

FIG. 6A is a diagram showing a method of changing an etalon temperature in grid-less control. In FIG. 6A, the horizontal axis represents the wavelength (in frequency), and the vertical axis represents a target value Iₘ₂/Iₘ₁ (the transmittance of the etalon 52). In FIG. 6A, the solid line indicates the wavelength characteristics-corresponding to an initial temperature value T_{Etalon} of the etalon 52, and the broken line indicates the wavelength characteristics exhibited by the etalon 52 whose temperature has been reduced by the second temperature control device 53. Here, in the control in which the target value Iₘ₂/Iₘ₁ at one of the black circles on the solid line is used as the feedback control target value, the etalon 52 is at the initial temperature value T_{Etalon}, so that the device lases atone of the fundamental wavelengths. On the other hand, when the etalon 52 is set at a temperature corresponding to the wavelength characteristics indicated by the broken line, the target value Iₘ₂/Iₘ₁ remains unchanged to be a value for obtaining the fundamental wavelength (the black circle on the broken line), but the actual lasing wavelength is shifted from the fundamental wavelength by the amount of change depending on the etalon characteristics. In other words, the etalon characteristics are shifted by an amount corresponding to the wavelength difference between the required wavelength and the fundamental wavelength, so that the required wavelength can be achieved directly with the target value Iₘ₂/Iₘ₁). Specifically, the calculation for changing the etalon temperature is carried out on the basis of the wavelength difference of between the required wavelength and the fundamental wavelength, and using this calculated value as the etalon temperature can achieve the required wavelength. In the example in FIG. 6A, the lasing wavelength can be shifted from the fundamental wavelength. λb to the required wavelength λ1.

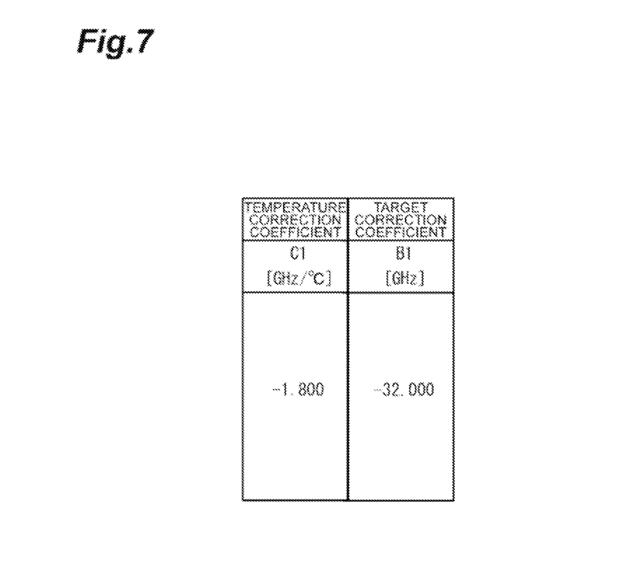

As described above, the wavelength characteristics of the etalon 52 are shifted depending on the temperature. The ratio of the amount of frequency change/amount of temperature change (in GHz/° C.) defined in the etalon 52 is called the temperature correction coefficient C1 of the etalon 52, where the wavelength is expressed in frequency. The temperature correction coefficient C1 is defined as the rate of change in the drive conditions of the variable wavelength laser with respect to wavelength change. The temperature correction coefficient C1 can be stored in the memory 60. FIG. 7 is an example of the temperature correction coefficient C1 which is stored in the memory 60. In the present embodiment, a single temperature correction coefficient C1 may be shared with each channel in FIG. 3.

The setting temperature for the etalon 52 for achieving the required wavelength in grid-less control is represented as “Tetlin_A” (in ° C.). Furthermore, the initial temperature for the etalon 52, in other words, the temperature of the etalon 52 corresponding to a selected fundamental wavelength is represented as “Tetln_B” (in ° C.). The Teltn_B corresponds to T_{Etalon} and is acquired from the memory 60. Moreover, the wavelength difference (absolute value) between the fundamental wavelength and the required wavelength in grid-less control is called ΔF (GHz). In this case, the relationship between these parameters can be expressed as shown in Formula (1) as below, and the setting temperature Tetln_A required in order to obtain the required wavelength in grid-less control can be determined on the basis of Formula (1):

Tetln_{—}A=Tetln_{—}B+ΔF1/C1 (1).

By controlling the temperature of the second temperature control device 53 to the setting temperature Tetln_A, the required wavelength in grid-less control is obtained by use of the target value Iₘ₂/Iₘ₁.

In the method of changing the etalon temperature, the lasing wavelength is changed by shifting the temperature of the etalon 52, so that this method allows the range of possible wavelength shift to be large, which is advantageous. On the other hand, change in the temperature of the etalon 52 may make the power consumption of the second temperature control device 53 large. More specifically, when the second temperature control device 53 is controlled such that the temperature of the etalon 52 is changed to a temperature away from an ambient temperature of the etalon 52, such a control makes the power consumption large. In the control from a fundamental wavelength to a required wavelength in the grid-less control, this method of changing the etalon temperature is effective in the control where the temperature of the etalon 52 approaches the detection temperature of the temperature detecting section 81.

For instance, when the temperature of the semiconductor laser 30 is made high, then heat exhausted from the first temperature control device 31 is transferred to the chassis 80. In this case, reducing the temperature of the etalon 52 makes the power consumption of the second temperature control device 53 large. In the semiconductor laser 30 according the present embodiment, the temperature of the second temperature control device 53 must be reduced in order to shift the transmission characteristics of the etalon 52 to the higher frequency region. Therefore, it is desirable to apply the method of changing an etalon temperature to the control in which the frequency becomes lower in the shifting of the wavelength from the fundamental wavelength to the required wavelength.

Next, the method of changing the target in the grid-less control will be described below. The method of changing the target carries out to change the target of the transmittance in the AFC control, without changing the temperature of the etalon 52 (a temperature value remaining unchanged), and that is, the target value Iₘ₂/Iₘ₁ is changed. FIG. 6B is a diagram illustrating the target change method.

By acquiring the relationship between the transmittance and the wavelength of the etalon 52, the amount of change in the target value Iₘ₂/Iₘ₁ can be determined with respect to the amount of change in the wavelength in grid-less control. For example, the relationship between the transmittance and the wavelength of the etalon 52 can be approximated by Formula (3), which is shown below. In Formula (3), Target_A[A.U.] indicates target value Iₘ₂/Iₘ₁ corresponding to the required wavelength in grid-less control, and Target_B[A.U.] indicates target value Iₘ₂/Iₘ₁ corresponding to the fundamental wavelength. A target correction coefficient B1 is stored in the memory 60, as shown in FIG. 7. Formula (3) is expressed in the first-order approximation, but may also be expressed in a higher-order approximation.

Target_{—}A=Target_{—}B+ΔF2/B1 (3)

In the method of changing the target, the temperature of the etalon 52 does not have to be changed, which is advantageous. On the other hand, the range of possible change of the target value Iₘ₂/Iₘ₁ is limited to a prescribed range in the slope from the trough to the peak of the transmittance characteristics of the etalon 52, and accordingly the range of possible wavelength shift is limited to the region corresponding thereto. Around the trough (bottom) region and the peak region in the transmittance characteristics of the etalon 52, the polarity in the change rate of the wavelength detection value to the wavelength is changed to be reversed, and accordingly it is desirable to use, as the range of possible change of the target value Iₘ₂/Iₘ₁, the sloping portion which is outside regions near the trough (bottom) and peak, in the transmission characteristics of the etalon 52.

It is thought that when the wavelength difference between the fundamental wavelength and the required wavelength is equal to or smaller than a prescribed value, the method of changing the target can be used. It is desirable to use the method of changing the target in the control in which the temperature of the etalon 52 is changed in a direction away from the detection temperature of the temperature detecting section 81. In the present embodiment, when the shifting of the wavelength carried out from the fundamental wavelength to the required wavelength makes the frequency higher, then it is desirable to adopt the method of changing the target.

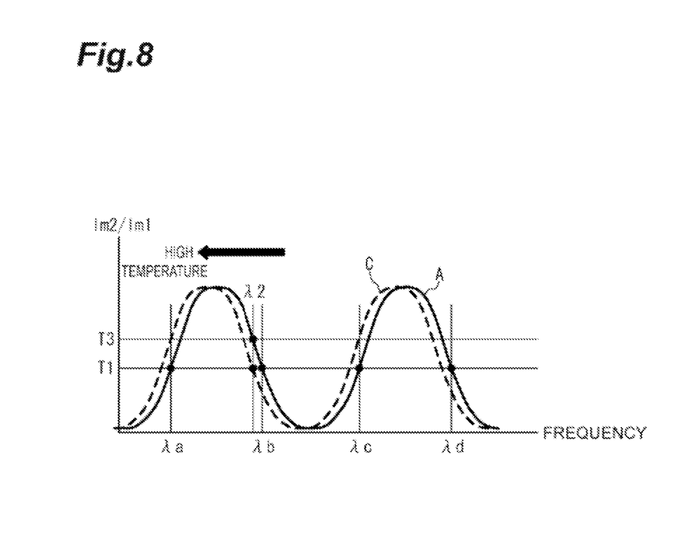

FIG. 8 is a diagram showing a control in which either the etalon temperature changing method or the target changing method is used alone. As shown in FIG. 8, when the wavelength difference between the fundamental wavelength λb and the required wavelength λ2 is small, then the required wavelength λ2 can be obtained simply by changing the target value Iₘ₂/Iₘ₁ from T1 to T3. Furthermore, since the required wavelength λ2 can be obtained by moving the transmittance characteristics of the etalon 52 to the higher-temperature side, then the temperature of the etalon 52 can be controlled to shift the characteristics from the characteristics A to the characteristics C.

Next, the combined use of the method of changing an etalon temperature and the method of changing a target will be considered below. For example, one use is that the wavelength difference can be shared between the method of changing the etalon temperature and the method of changing the target. Furthermore, another use is that when the amount of the wavelength difference is insufficient for the control by the method of changing the target alone, then the method of changing the temperature of the etalon can be used to compensate. Moreover, it is also thought that the temperature of the etalon 52 is controlled by the method of changing the etalon temperature to be changed as close as possible to the ambient temperature, and then the resultant temperature can be adjusted to the required wavelength by the method of changing the target.

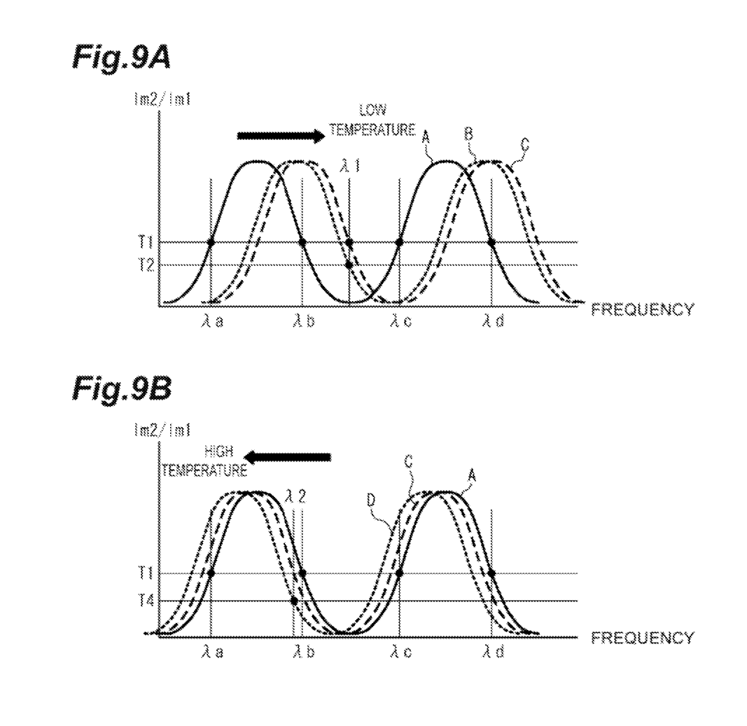

FIG. 9A is a diagram showing one example where the method of changing the etalon temperature and the method of changing the target are combined with each other. In the example in FIG. 9A, when the target value Iₘ₂/Iₘ₁ is the same value, T1, as in grid control, achieving a lasing wavelength at λ1 requires the transmittance characteristics C. The control in this case makes the range of decrease in the temperature of the etalon 52 large, so that the power consumption of the second temperature control device 53 becomes large. Therefore, in the example in FIG. 9A, the target value Iₘ₂/Iₘ₁ is changed to T2. The transmittance characteristics of the etalon 52 are shifted from the characteristics A to the characteristics B to compensate for the shortage of the wavelength difference. In this case, changing the target value Iₘ₂/Iₘ₁ to T2 can reduce the amount of driving of the second temperature control device 53 towards the low-temperature side.

FIG. 9B is a diagram showing another example where the method of changing the etalon temperature and the method of changing the target are combined with each other. In the example in FIG. 9B, the wavelength difference between the fundamental wavelength λb and the required wavelength λ2 is small. Hence the wavelength λ2 is obtained simply by increasing the target value Iₘ₂/Iₘ₁ on the slope under the conditions of the characteristics A. However, from the viewpoint of reducing the power consumption, it is desirable for the temperature of the etalon 52 to come as near as possible to the ambient temperature. In the present embodiment, it is desirable to shift the temperature of the etalon 52 to the high-temperature side, as far as possible. Therefore, the required wavelength λ2 could be achieved by shifting the characteristics of the etalon 52 from the characteristics A to the characteristics C, but the characteristics of the etalon 52 may be shifted further to the characteristics D and then the target value Iₘ₂/Iₘ₁ may be reduced on the slope thereof. In this case, the power consumption of the second temperature control device 53 can be reduced as compared to the control in which the transmittance characteristics of the etalon 52 are shifted from the characteristics A to the characteristics C.

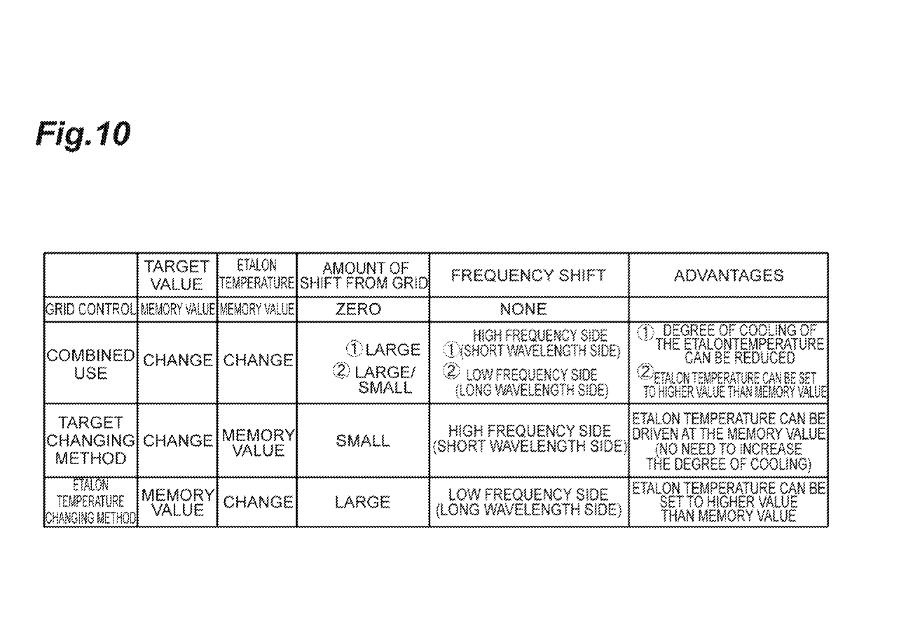

FIG. 10 is a systematic view showing the table for grid-less control. As shown in FIG. 10, the method of changing the etalon temperature does not change the target value Iₘ₂/Iₘ₁, but changes the temperature of the etalon 52. The wavelength difference with respect to the fundamental wavelength may be large or small. When the wavelength is shifted towards the low-frequency side, it is possible to make the temperature of the etalon 52 higher than the initial setting value, and the power consumption of the second temperature control device 53 can be reduced. Consequently, it is desirable to use this method in the shifting of wavelength to the low-frequency side.

Next, the method of changing the target does not change the temperature of the etalon 52, but changes the target value Iₘ₂/Iₘ₁. The wavelength difference with respect to the fundamental wavelength is limited to a prescribed range of the slope portion of the etalon 52 and therefore is not wide. The etalon temperature does not have to be changed, so that shifting wavelength to the high-frequency side does not have to make the power consumption of the second temperature control device 53 large, which is a beneficial effect. Consequently, it is desirable to use this method when shifting wavelength to the high-frequency side.

Next, in a combined use of both methods, the temperature of the etalon 52 and the target value Iₘ₂/Iₘ₁ both are changed. The wavelength difference with respect to the fundamental wavelength may be large or small. When shifting wavelength to the high-frequency side, the degree of cooling of the etalon 52 can be reduced, compared to the shifting of the wavelength by means of the temperature of the etalon 52 alone. This allows the reduction in the power consumption. When shifting the wavelength towards the low-frequency side, it is possible to make the temperature of the etalon 52 higher than the initial setting value, and the power consumption of the second temperature control device 53 can be reduced. By shifting the transmittance characteristics of the etalon 52 as in FIG. 9B, it is possible to significantly reduce the power consumption of the second temperature control device 53.

In the case where the initial setting value of the etalon 52 is set to a relatively low value, there may be one case where shifting the wavelength in the opposite direction to that in FIG. 10 leads to a reduction in power consumption. Therefore, in FIG. 10, the frequency shift is indicated in round brackets.

In this way, when carrying out grid-less control, it is possible to use either one or both of the method of changing the etalon temperature and the method of changing the target. The controller 70 selects either one of these methods and implements the selected one. This enables the grid-less control with a high degree of freedom.

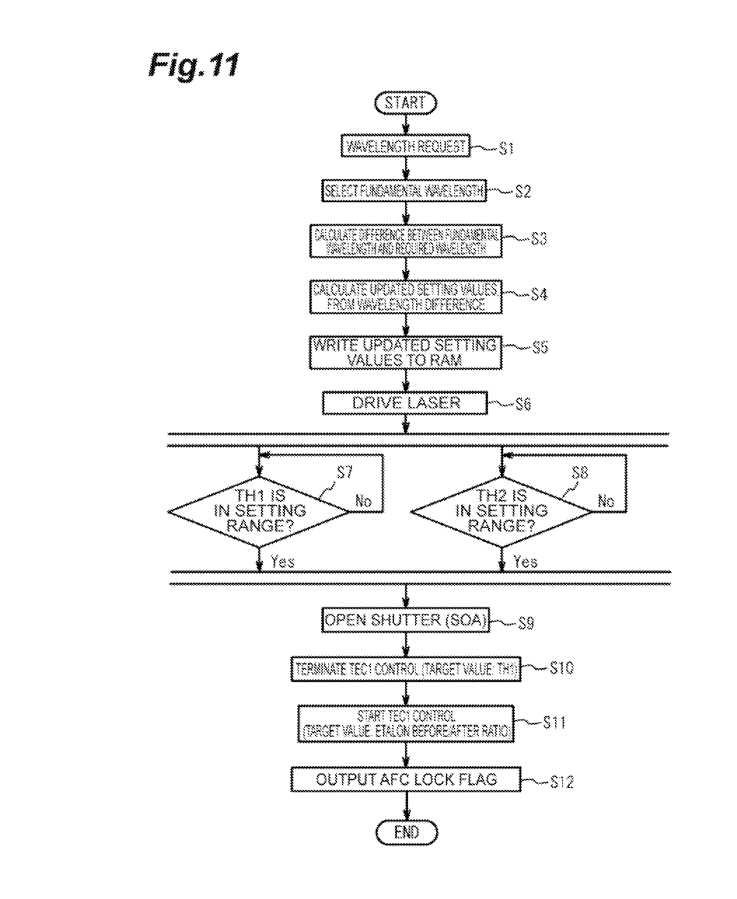

FIG. 11 is one example of a flowchart in a grid-less control. As shown in FIG. 11, the controller 70 receives a required wavelength (in step S1). This required wavelength is used as a required wavelength for the grid-less control, and is entered by means of a peripheral input/output device. Typically, an input/output device, which can be compliant with RS232C standards, is employed.

The required wavelength in grid-less control is accepted over the whole wavelength range between the fundamental wavelengths stored in the memory 60. In other words, even if an input that has been entered therethrough as a required wavelength does not conform to any of the fundamental wavelengths, this input is not rejected. Furthermore, the variable wavelength laser device 100 is configured such that the control for achieving the required wavelength, which has been input, can be to carried out through the wavelength range from a fundamental wavelength up to the fundamental wavelength adjacent thereto. For this purpose, the shifting of the wavelength characteristics of the etalon 52 favorably ranges from a fundamental wavelength to the adjacent fundamental wavelength. Furthermore, the wavelength (start grid) available for the maximum value or minimum value, and the fundamental wavelength difference (grid wavelength interval) of the fundamental wavelengths shown in FIG. 3 are recorded in the memory 60.

Next, the controller 70 selects the fundamental wavelength corresponding to the required wavelength (in step S2). For example, the controller 70 determines the difference between the required wavelength and the start grid wavelength, divides this difference by the grid wavelength interval, and calculates the resulting integer part of the quotient, which is used as the channel number Ch. The controller 70 selects a fundamental wavelength corresponding to the channel number Ch thus obtained. For example, the wavelength is obtained by the following: multiplying the value, obtained as the channel number Ch, by the grid wavelength interval to provide the product; and then adding the start grid wavelength to the product to provide the sum. Then, the controller 70 calculates the wavelength difference ΔF1 between the fundamental wavelength and the required wavelength in grid-less control (in step S3).

Next, the controller 70 calculates an updated setting value on the basis of the wavelength difference ΔF1 (in step S4). In step S4, the controller 70 selects the use of either one or both of the following methods: the method of changing the etalon temperature and the method of changing the target, which have been described above. If the method of changing the etalon temperature is selected, the controller 70 calculates an updated setting value for the temperature of the etalon 52, whereas if the method of changing the target is selected, the controller 70 calculates an updated setting value for the target value Iₘ₂/Iₘ₁. When a combined use of the method of changing the etalon temperature and the method of changing the target is selected, the controller 70 calculates updated setting values for both the temperature of the etalon 52 and the target value Iₘ₂/Iₘ₁. Furthermore, the controller 70 calculates the drive conditions of the semiconductor laser 30 at the required wavelength in grid-less control. For example, the controller 70 refers to a correction coefficient stored in the memory 60, and calculates updated setting values on the basis of the initial current value I_{LD}; the initial temperature value T_{LD}; the initial power values P_{Heater1} to P_{Heater3}; and the wavelength differential ΔF1.

Next, the controller 70 writes the updated setting values to a RAM contained in the controller (in step S5), and the controller 70 drives the semiconductor laser 30 by use of the updated setting values that have been written to the RAM (in step S6). The controller 70 controls the SOA region C at this moment such that the semiconductor laser 30 does not emit light therefrom. Next, the controller 70 determines whether or not the detection temperature TH1 of the first thermistor 32 is in the range of T_{LD}) (in step S7). Here, the range of T_{LD} is defined as a prescribed range at the center of which the temperature value T_{LD} of the updated setting value is. When the determination in step S7 indicates “No”, then the controller 70 changes the current value, which is to be supplied to the first temperature control device 31, in such a manner that the detection temperature TH1 of the first thermistor 32 approaches the temperature value T_{LD}.

In parallel with step S7, the controller 70 determines whether or not the detection temperature TH2 of the second thermistor 55 falls within the setting range (in step S8). The setting range in the present procedure is determined on the basis of the setting temperature Tetln_A which is included in the updated setting values. For example, the setting range can be defined as a prescribed range at the center of which the setting temperature Tetln_A is. In another procedure in which the temperature of the etalon 52 is not changed, then the setting range is defined as a prescribed range at the center of which the initial setting value Tetln_B is. When the determination in step S8 indicates “No”, then the controller 70 changes the current value, which is to be supplied to the second temperature control device 53, in such a manner that the detection temperature TH2 of the second thermistor 55 approaches the setting temperature.

The controller 70 is in standby mode until the determination indicating “Yes” is made in step S7 and step S8. When the determination in both step S7 and step S8 is made “Yes”, then the controller 70 carries out a shutter open operation (in step S9). More specifically, the controller 70 controls the current, which is to be supplied to the electrode 21 of the SOA region C, to the initial current value I_{SOA}. Consequently, the semiconductor laser 30 emits a laser beam, which has the updated wavelength based on the updated setting values.

Next, the controller 70 terminates temperature control, which is carried out through the first temperature control device 31, for setting the temperature value T_{LD} to the control target (in step S10). Then, the controller 70 starts the AFC control by use of the first temperature control device 31 (in step S11). In other words, feedback control is carried out such that the temperature of the first temperature control device 31 satisfies the target value Iₘ₂/Iₘ₁. The ratio between the input light and the output light of the etalon 52 (the front/back ratio) expresses the lasing wavelength of the semiconductor laser 30. Furthermore, the first temperature control device 31 is used as a parameter which controls the wavelength of the semiconductor laser 30. In other words, in step S11, the wavelength of the semiconductor laser 30 is controlled by feedback control of the temperature of the first temperature control device 31, in such a manner that the front/back ratio becomes Iₘ₂/Iₘ₁. Consequently, the required wavelength is achieved.

Upon the confirmation that the target value Iₘ₂/Iₘ₁ is within the prescribed range at the center of which the target value Iₘ₂/Iₘ₁ for the fundamental wavelength selected in step S2 is, the controller 70 outputs an AFC lock flag (step S12). Then, the execution of the flowchart is terminated.

In the present embodiment, when implementing grid-less control, it is possible to select either one of the method of changing the etalon temperature and the method of changing the target, or combination of both methods, and to implement the selected one, thereby achieving grid-less control with a high flexibility. Furthermore, determining to select the method depending on the sign of the wavelength difference ΔF can make the criteria of determination simplified.

Moreover, in grid-less control, when increasing the lasing frequency of the semiconductor laser 30, adopting the target changing method can be avoid increase in the power consumption of the second temperature control device 53. On the other hand, when reducing the lasing frequency, employing the etalon temperature changing method can be reduce the power consumption of the second temperature control device 53.

Moreover, in grid-less control, in the procedure in which the temperature of the etalon 52 is made to approach the ambient temperature, the method of changing the etalon temperature allows the reduction in the power consumption of the second temperature control device 53. In the procedure in which the temperature of the etalon 52 is made to change away from the ambient temperature, the method of changing the target can avoid increase in the power consumption of the second temperature control device 53.

In the example described above, a solid etalon is employed as the etalon 52, but it is also possible to use an etalon other than it. For example, a liquid crystal etalon having a liquid crystal layer interposed between mirrors can be used as the etalon 52. In this case, the voltage applied to the liquid crystal can be controlled to shift the wavelength characteristics of the liquid crystal etalon. Furthermore, an air gap etalon with a variable-length gap, which can vary in response to the applied voltage, formed by the mirrors thereof can be used as the etalon 52. In this case, it is possible to shift the wavelength characteristics of the air gap etalon by controlling the applied voltage. In both the liquid crystal etalon and the air gap etalon, temperature control is performed by the second temperature control device 53. However, the temperature control in this case is carried out not for shifting the wavelength characteristics, but for preventing variation in the wavelength characteristics caused by undesired temperature factors. Therefore, the temperature is controlled to keep the temperature in a constant value.

In the respective examples described above, the selected fundamental wavelength may be referred to as the first wavelength. Furthermore, the required wavelength may be referred to as the second wavelength. The target value Iₘ₂/Iₘ₁ may be referred to as the target setting value of the etalon 52. The temperature of the etalon 52 may be referred to as the control value for determining the wavelength characteristics of the etalon 52.

Having described and illustrated the principle of the invention in a preferred embodiment thereof, it is appreciated by those having skill in the art that the invention can be modified in arrangement and detail without departing from such principles. We therefore claim all modifications and variations coming within the spirit and scope of the following claims.

What is claimed is:

1. A method for controlling a variable wavelength laser with a memory storing drive conditions for lasing at a first wavelength, a lasing wavelength of the variable wavelength laser being controlled based on a difference between a target value and a wavelength detection result, the wavelength detection result being provided by a wavelength detecting section having an etalon,
the method comprising:
a first step of acquiring second-wavelength information, wavelength-difference information, and a first control value and a first target setting value from among the drive conditions, the second-wavelength information indicating a value of a second wavelength different from the first wavelength, the wavelength-difference information indicating a wavelength difference with respect to the first wavelength, the first target setting value being provided for the etalon, and the first control value defining wavelength characteristics of the etalon;
a second step of selecting one of the following calculations based on the wavelength difference, the first target setting value and the first control value: calculation of a second target setting value for the etalon; calculation of a second control value defining wavelength characteristics of the etalon; and calculation of both the second target setting value and the second control value, the second target setting value corresponding to the second wavelength, and the second control value corresponding to the second wavelength, and carrying out the calculation thus selected; and
a third step of, if the calculation of the second target setting value is carried out in the second step, setting a control target value of a wavelength detection result as the second target setting value and then controlling a wavelength of the variable wavelength laser, the wavelength detection result being obtained by the wavelength detecting section.

2. The method for controlling a variable wavelength laser according to claim 1, wherein the selection in the second step is made on the basis of a sign of a wavelength difference between the first wavelength and the second wavelength.

3. The method for controlling a variable wavelength laser according to claim 1, wherein
a control value determining the wavelength characteristics of the etalon indicates a temperature of the etalon;
the temperature of the etalon is controlled by a temperature control device including a Peltier device; and
a selection enabling a power consumption of the temperature control device to become small is made in the second step.

4. The method for controlling a variable wavelength laser according to claim 3, wherein, in a procedure in which both the second target setting value and the second control value are calculated in the second step, the second target setting value is shifted towards a value enabling a small power consumption of the temperature control device.

5. The method for controlling a variable wavelength laser according to claim 1, wherein, in a procedure in which both the second target setting value and the second control value are calculated in the second step, the second control value is calculated when the wavelength difference is outside a variable range of the second target setting value.

6. The method for controlling a variable wavelength laser according to claim 1, wherein the selection of the second step is made on the basis of a relationship between the temperature of the etalon and an ambient temperature of the etalon.

7. A variable wavelength laser device, comprising:
a variable wavelength laser;
a wavelength detecting section including an etalon, the wavelength detecting section detecting a wavelength of output light emitted by the variable wavelength laser;
a memory storing drive conditions for the variable wavelength laser; and
a controller
which acquires second-wavelength information, wavelength-difference information, and a first control value and a first target setting value from among the drive conditions on the basis of a difference between a target value and a wavelength detection result provided by the wavelength detecting section, the second-wavelength information indicating a second wavelength, the second wavelength being different from a first wavelength, the wavelength-difference information indicating a wavelength difference with respect to the first wavelength, the first target setting value being provided for the etalon, and the first control value determining wavelength characteristics of the etalon,
which selects, on the basis of the wavelength difference, the first target setting value and the first control value, one of the following: to perform calculation of a second target setting value for the etalon, the second target setting value corresponding to the second wavelength; to perform calculation of a second control value determining wavelength characteristics of the etalon, the wavelength characteristics of the etalon corresponding to the second wavelength; and to perform calculation of both the second target setting value and the second control value, and implements the calculation thus selected, and
which controls a wavelength of the variable wavelength laser by using, as the second target setting value, a control target value of a wavelength detection result obtained by the wavelength detecting section, in response to the selection of the calculation of the second target setting value.

8. The variable wavelength laser device according to claim 7, wherein the controller makes a selection on the basis of a sign of a wavelength difference between the first wavelength and the second wavelength.

9. The variable wavelength laser device according to claim 7, further comprising a temperature control device including a Peltier device, the Peltier device controlling a temperature of the etalon,
wherein a control value defining the wavelength characteristics of the etalon is the temperature of the etalon, and the controller selects a temperature of the etalon enabling a power consumption of the temperature control device to be made small.

10. The variable wavelength laser device according to claim 9, wherein, in the selection in which both the second target setting value and the second control value are calculated, the controller shifts the second target setting value towards a value enabling a power consumption of the temperature control device to become small.

11. The variable wavelength laser device according to claim 7, wherein, in the selection in which both the second target setting value and the second control value are calculated, the controller calculates the second control value if the wavelength difference is outside a variable range of the second target setting value.

12. The variable wavelength laser device according to claim 7, wherein the controller makes a selection in the second step on the basis of a relationship between a temperature of the etalon and an ambient temperature of the etalon.

13. The variable wavelength laser device according to claim 7, further comprising a temperature detecting section which detects the temperature of the etalon.
